(19) United States
(12) Patent Application Publication
(10) Pub. No.: US 2026/0364754 A1
(43) Pub. Date: Nov. 19, 2026

(54) Impact Tool Components and Methods of Heat Treating Same

(71) Applicant: Milwaukee Electric Tool Corporation, Brookfield, WI (US)

(72) Inventors: Edward N. Rahe, Oak Creek, WI (US); Jacob P. Schneider, Cedarburg, WI (US); Joseph T. Lottes-Paukner, Waukesha, WI (US)

(21) Appl. No.: 19/689,606

(22) Filed: May 27, 2026

Related U.S. Application Data
(63) Continuation-in-part of application No. PCT/US2026/027991, filed on May 13, 2026.
(60) Provisional application No. 63/807,397, filed on May 16, 2025.

(51) Int. Cl. B25B 21/02; C21D 1/10; C21D 1/58; C21D 1/607; C21D 1/613; C21D 6/00; C21D 9/30

(52) U.S. Cl. CPC B25B 21/02; C21D 1/10; C21D 1/58; C21D 1/607; C21D 1/613; C21D 6/001; C21D 9/30; C21D 2211/002; C21D 2211/008

(57) ABSTRACT

Embodiments of an anvil for an impact tool are provided. The anvil includes an impact receiving portion at an end of the anvil in which the impact receiving portion includes a lug having an impact receiving surface that receives impact from a hammer of the impact tool. The anvil further includes a shank portion extending from the impact receiving portion and a drive portion located at an end of the shank portion opposite from the impact receiving portion. The drive portion includes a plurality of drive surfaces configured to engage a tool bit. At least a portion of the impact receiving surface has a hardness of at least 60 HRC.

### CROSS-REFERENCE TO RELATED PATENT APPLICATIONS

The present application is a continuation-in-part of International Application No. PCT/US2026/027991, filed May 13, 2026, which claims the benefit of priority to U.S. Provisional Application No. 63/807,397, filed May 16, 2025, each of which is incorporated herein by reference in its entirety.

### BACKGROUND

The present disclosure relates to power tool components, such as anvils for impact tools, and methods of manufacturing such components.

### SUMMARY

In a first aspect, embodiments of the present disclosure relate to a component, such as an anvil or a camshaft, for an impact tool. The component comprises a first end, a second end, and a shank portion extending between the first end and the second end. The shank portion comprises an outer surface. At least a portion of the outer surface comprises a hardness of at least 60 HRC.

In a second aspect, embodiments of the present disclosure relate to a component in the form of an anvil having an impact receiving portion at the first end in which the impact receiving portion includes a lug having an impact receiving surface that receives impact from a hammer of the impact tool. The anvil further comprises a drive portion located at the second end of the shank portion opposite from the impact receiving portion at the first end. The drive portion includes a plurality of drive surfaces configured to engage a tool bit.

In a third aspect, embodiments of the present disclosure relate to the component of the second aspect in which the portion of the impact receiving surface comprises a case depth of at least 2.0 mm.

In a fourth aspect, embodiments of the present disclosure relate to the component of any of the first aspect to the third aspect in which the component comprises a medium carbon steel containing nickel.

In a fifth aspect, embodiments of the present disclosure relate to the anvil of any of the first aspect to the fourth aspect in which the anvil comprises a steel with alloying additions of at least 4.0 wt. %, such as 35Cr2Ni4MoA or 30NiCrMo8 steel.

In a sixth aspect, embodiments of the present disclosure relate to the component of the first aspect in which the component is a camshaft configured to be disposed between a motor at an upstream end and an anvil at a downstream end. The camshaft comprises a flange at the first end and a post at the second end, and the shank portion comprises a hollow interior.

In a seventh aspect, embodiments of the present disclosure relate to the component of any of the first aspect to the sixth aspect in which the component comprises a bainitic microstructure.

In an eighth aspect, embodiments of the present disclosure relate to the component of the seventh aspect in which the bainitic microstructure comprises retained martensite and in which the retained martensite is present in an amount of 5% or less.

In a ninth aspect, embodiments of the present disclosure relate to a method of heat treating a component, such as an anvil or a camshaft for an impact tool. In the method, the component is austenitized in a carbon enriching atmosphere with a carbon potential in a range of 0.70% to 0.90%. The component comprises a medium carbon, high alloy steel. The component is quenched in air to room temperature. The component is tempered at a minimum temperature of 250 °C for a minimum time of 1 hour. A surface of the component is induction hardened to a hardness of at least 60 HRC, and the component is tempered at a minimum temperature of 120 °C for a minimum time of 1 hour.

In a tenth aspect, embodiments of the present disclosure relate to the method of the ninth aspect in which the component is a camshaft having a hollow interior. The method further comprises masking an interior surface of the camshaft to limit hardening of the interior surface relative to an exterior surface of the camshaft.

In an eleventh aspect, embodiments of the present disclosure relate to a method of heat treating a component, such as an anvil or camshaft, for an impact tool. In the method, the component is austenitized and quenched in at least one of helium or nitrogen gas. The component is induction tempered at a temperature in a range of about 500 °C to about 600 °C for a time in a range of about 1 second to about 10 seconds. A surface of the component is induction hardened to a hardness of at least 56 HRC.

In a twelfth aspect, embodiments of the present disclosure relate to a method of heat treating a component, such as an anvil or a camshaft, for an impact tool. In the method, the component is austenitized and intensively quenched using water. The component is tempered at a minimum temperature of 275 °C for a minimum time of 1 hour.

In a thirteenth aspect, embodiments of the present disclosure relate to a method of heat treating a component, such as an anvil or a camshaft, for an impact tool. In the method, the component is austenitized and quenched in at least one of helium or nitrogen gas. The component is tempered at a minimum temperature of 275 °C for a minimum time of 1 hour. The component is induction hardened using a first frequency to pre-heat the component and a second frequency to harden a surface of the component to a hardness of at least 56 HRC. The component is tempered at a minimum temperature of 120 °C for a minimum time of 1 hour.

In a fourteenth aspect, embodiments of the present disclosure relate to a method of heat treating a component, such as an anvil or a camshaft, for an impact tool. In the method, the component is austenitized in a carbon enriching atmosphere with a carbon potential in a range of 0.70% to 0.90%. The component is quenched and held at a temperature in the range of 250 °C to 400 °C for at least 30 minutes. Quenching may be performed in a salt bath or in air, water, or oil, for example. The component is tempered at a minimum temperature of 150 °C for a minimum time of 1 hour. The component comprises a bainitic microstructure.

In a fifteenth aspect, embodiments of the present disclosure relate to the method of the fourteenth aspect in which the component is a camshaft having a hollow interior. The method further comprises masking an interior surface of the camshaft to limit hardening of the interior surface relative to an exterior surface of the camshaft.

Additional features and advantages will be set forth in the detailed description which follows, and, in part, will be readily apparent to those skilled in the art from the description or recognized by practicing the embodiments as described in the written description included, as well as the appended drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments.

### BRIEF DESCRIPTION OF THE DRAWINGS

This application will become more fully understood from the following detailed description, taken in conjunction with the accompanying figures, wherein like reference numerals refer to like elements in which:

FIG. 1 is a cross-sectional view of a power tool including an impact mechanism having an anvil and a camshaft, according to an embodiment of the disclosure;

FIG. 2 is a front perspective view of the anvil of the power tool shown in FIG. 1;

FIG. 3 is a rear perspective view of the anvil of the power tool shown in FIG. 1;

FIG. 4 is a cross-sectional view of a camshaft of the power tool shown in FIG. 1;

FIG. 5 is a flow diagram of a first heat treating process, according to one or more embodiments of the present disclosure;

FIG. 6 is a flow diagram of a second heat treating process, according to one or more embodiments of the present disclosure;

FIG. 7 is a flow diagram of a third heat treating process, according to one or more embodiments of the present disclosure;

FIG. 8 is a flow diagram of a fourth heat treating process, according to one or more embodiments of the present disclosure; and

FIG. 9 is a flow diagram of a fifth heat treating process, according to one or more embodiments of the present disclosure.

### DETAILED DESCRIPTION

Referring generally to the figures, various embodiments of a drivetrain component of an impact tool are provided as well as methods of heat treating same. As will be discussed more fully below, the drivetrain component may be at least one of an anvil or a camshaft. Advantageously, the heat treatment methods disclosed herein provide higher surface hardness while maintaining a softer interior. In this way, the surface is able to resist deformation while the interior has toughness to resist fracture. These and other aspects and advantages of the disclosed drivetrain component and method of heat treating same will be discussed more fully below in relation to the embodiments described herein and shown in the figures. Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways.

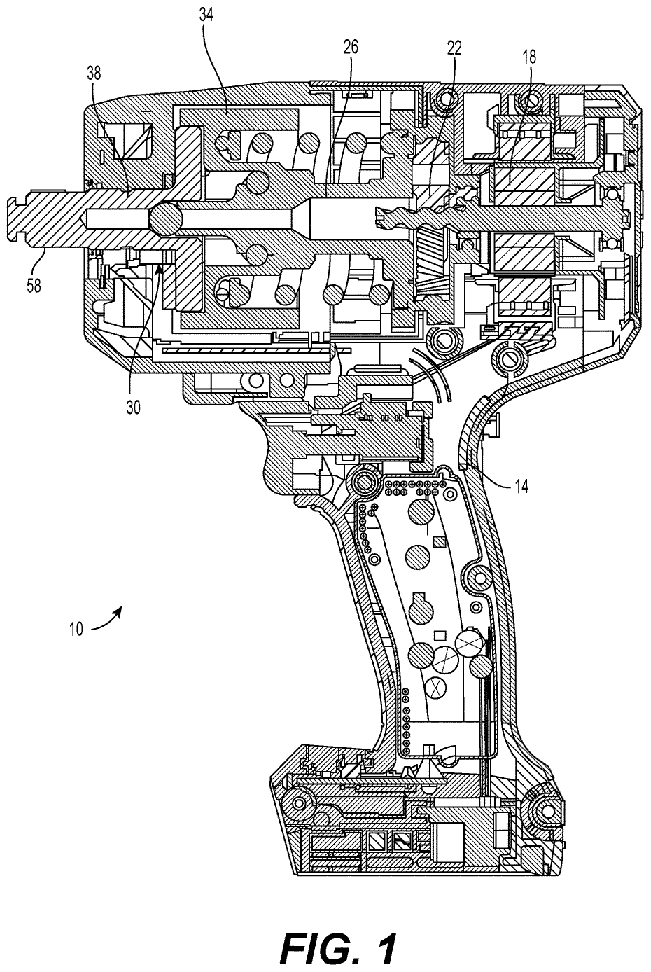

FIG. 1 illustrates a power tool 10, and more specifically, a rotary impact tool such as an impact wrench. The power tool 10 includes, among other things, a housing 14, a motor 18, a gear assembly 22, a camshaft 26, and an impact mechanism 30. The motor 18 transmits torque to and drives rotation of the gear assembly 22 and the camshaft 26. The gear assembly 22 and the camshaft 26 transmit torque to and drive rotation of the impact mechanism 30. The impact mechanism 30 has a hammer 34 configured to strike an anvil 38 to impart torque on the anvil 38 and provide a torque output for the power tool 10. As such, operation of the power tool 10 may cause fatigue crack initiation, growth, and eventually, fracture, of the anvil 38 from repeated striking by the hammer 34.

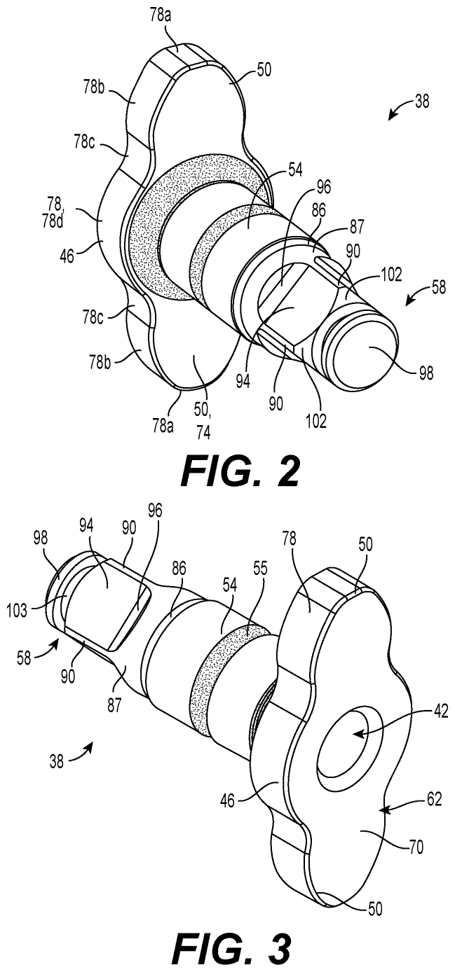

FIGS. 2 and 3 illustrate the anvil 38 including an impact receiving portion 46, a drive portion 58 opposite the impact receiving portion 46, and a body or shank 54 extending between the impact receiving portion 46 and the drive portion 58. The illustrated impact receiving portion 46 includes a central bore or aperture 42 and a pair of lugs 50. The aperture 42 is formed on a rear side 62 of the impact receiving portion 46 and sized and positioned to receive and rotationally support a front end of the camshaft 26 (FIG. 1) when the power tool 10 is assembled. In other embodiments, the aperture 42 may be omitted, or the aperture 42 may be replaced by a projecting boss extending into a corresponding aperture in the front end of the camshaft 26.

The impact receiving portion 46 includes a rear face 70, a front face 74, and a peripheral face 78 extending between the rear face 70 and the front face 74. The aperture 42 is defined in the rear face 70, and the shank 54 extends from the front face 74. In the illustrated embodiment, the impact receiving portion 46 includes two lugs 50 that extend away from the aperture 42 and the shank 54 in a direction that is perpendicular to an extending direction of the shank 54. Stated another way, the lugs 50 are spaced diametrically across from each other relative to the aperture 42 such that the lugs 50 extend away from each other. The lugs 50 are configured to receive an impact (i.e., a torque transmission) from the hammer 34, and the anvil 38 transmits the impact (i.e., the torque) to the drive portion 58 through the shank 54.

With reference to FIG. 2, the peripheral face 78 of the impact receiving portion 46 includes tip portions 78a defined at a distal end of each lug 50, impact receiving surfaces 78b extending from the tip portions 78a, transition surfaces 78c extending from the impact receiving surfaces 78b, and a central portion 78d. The impact receiving surfaces 78b may have an involute profile in some embodiments and are configured to be directly struck by the hammer 34 during operation of the power tool 10. The central portion 78d has a constant radius in the illustrated embodiment, and the transition surfaces 78c provide a smooth transition between the impact receiving surfaces 78b and the central cylindrical portion 78d. In the illustrated embodiment, the concavity of the peripheral face 78 changes at the transition surfaces 78c.

Referring to FIGS. 2-3, the illustrated drive portion 58 includes a step 86, a body portion 87, a plurality of chamfers 90, a plurality of drive surfaces 94, a plurality of transition surfaces 96, and a flange 98. The step 86 extends from the shank 54 and converges radially inwardly to the body portion 87. The shank 54 and the body portion 87 may each have constant diameters in some embodiments, with the diameter of the body portion 87 being less than the diameter of the shank 54. In some embodiments, the shank 54 and/or the body portion 87 may include one or more grooves 55.

The drive surfaces 94 are formed as planar surfaces, which, in some embodiments, may be machined into the body portion 87. Each drive surface 94 is perpendicular to its adjacent drive surfaces 94, such that the drive surfaces 94 define a square-shaped drive configured to receive square-drive tool bits, such as sockets, or the like. As such, in the illustrated embodiment, the drive portion 58 includes four drive surfaces 94. The transition surfaces 96 are formed at the rear (proximal) end of the drive surfaces 94 and curve outwardly toward the body portion 87 to transition between the square cross-sectional shape defined by the drive surfaces 94 and the circular cross-sectional shape defined by the body portion 87. In other embodiments, the drive surfaces 94 may have other geometries to engage other types of tool bits.

With continued reference to FIGS. 2-3, the chamfers 90, which may be un-machined portions of the body portion 87, extend between and interconnect adjacent drive surfaces 94. In the illustrated embodiment, rounded end surfaces 102 are formed at forward (distal) end of the chamfers 90 and drive surfaces 94. A groove 103 is defined between the rounded end surfaces 102 and the flange 98. The groove 103 is configured to receive a ring (e.g., a rubber o-ring; not shown). The ring may engage the interior of a connected tool bit to provide increased friction, thereby retaining the tool bit on the drive portion 58. In other embodiments, one or more of the drive surfaces 94 may include a bore configured to receive a detent (e.g., a ball detent) to retain the tool bit on the drive portion 58. In such embodiments, the flange 98 and groove 103 may be omitted.

The anvil 38 is subjected to repeated, localized, high-magnitude forces during operation of the power tool 10. Accordingly, it may be desirable to strengthen the anvil without making it too brittle, and thus, the anvil 38 may benefit from balancing hardness to resist deformation and toughness to resist fracture. Embodiments of the present disclosure thus relate to various methods of heat treating the anvil to provide that balance of properties.

In one or more embodiments, the anvil 38 is formed from a steel alloy, in particular a steel alloy comprising nickel. Advantageously, adding nickel to a steel alloy tends to improve impact strength. In one or more embodiments, the steel alloy is a mild carbon alloy steel or a medium carbon alloy steel. In one or more embodiments, the steel alloy is a high alloy steel (i.e., containing greater than 4 wt. % of alloying additions). In one or more embodiments, the steel alloy is a low alloy steel (i.e., containing 4 wt. % or less of alloying additions). In one or more embodiments, the anvil 38 is comprised of 35Cr2Ni4MoA steel, which has a nominal composition (in wt. %) of approximately 0.37% C, 0.37% Mn, 0.41% Si, 1.75% Cr, 4.1% Ni, 0.20% Mo, 0.006% S, 0.006% P, and balance of Fe and unavoidable impurities. In one or more embodiments, the anvil 38 is comprised of 30NiCrMo8 steel, which has a nominal composition (in wt. %) of approximately 0.26-0.34% C, 0.50-0.80% Mn, 0.40% Si, 1.80-2.20% Cr, 1.80-2.20% Ni, 0.30-0.50% Mo, 0.035% S (max), 0.025% P (max), and balance of Fe and unavoidable impurities.

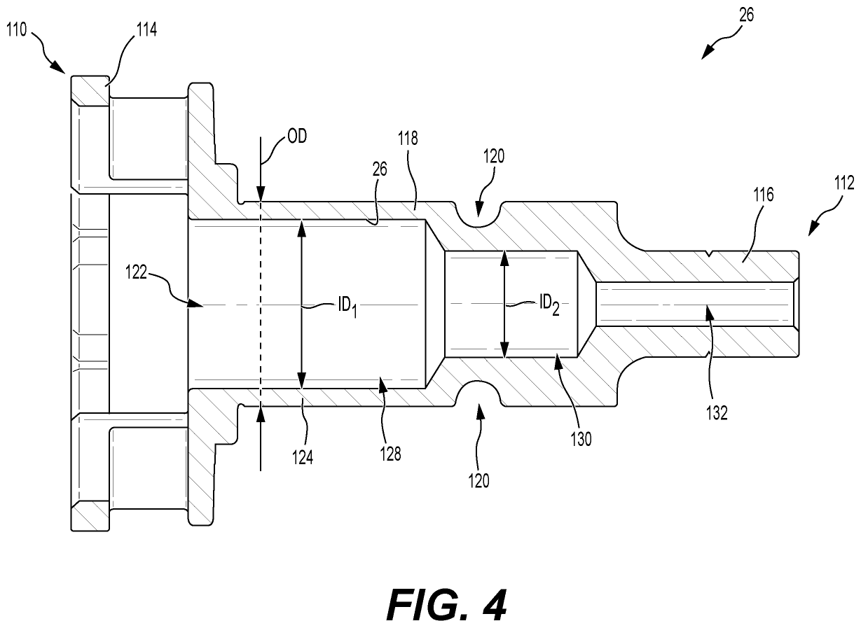

FIG. 4 depicts a cross-section of an exemplary embodiment of a camshaft 26 according to the present disclosure. The camshaft 26 has a first end 110 and a second end 112. A flange 114 is disposed at the first end 110, and the flange acts as a ring carrier of a planetary gear drive connected to the motor 18 of the power tool 10. A post 116 is disposed at the second end 112. The post 116 is configured to be inserted into the aperture 42 of the anvil 38 and rotates within the aperture 42 of the anvil 38. Disposed between the flange 114 and the post 116 is an intermediate shaft 118 on which cam grooves 120 are formed. The cam grooves 120 are configured to receive cam balls that provide engagement between the camshaft 26 and the hammer 34 such that rotational motion of the camshaft 26 is transferred to the hammer 34, which in turn drives the anvil 38.

As can be seen in FIG. 4, the camshaft 26 has a hollow interior 122. In particular, the intermediate shaft 118 has an exterior surface 124 and an interior surface 126. In one or more embodiments, the exterior surface 124 has a substantially constant outer diameter OD (except for the location of the cam grooves 120). In one or more embodiments, the interior surface 126 defines a first region 128 and a second region 130. The first region 128 has a first inner diameter ID₁, and the second region 130 has a second inner diameter ID₂. In one or more embodiments, the first inner diameter ID₁ is greater than the second inner diameter ID₂. The distance between the outer diameter OD and the first inner diameter ID₁ defines a first wall thickness T₁, and the distance between the outer diameter and the second inner diameter ID₂ defines a second wall thickness T₂. In one or more embodiments, the post 116 includes a central bore 132 that has a smaller diameter than the second region 130.

Conventionally, the anvil 38 and camshaft 26 (collectively, “component”) are prepared in a process involving quenching and tempering followed by induction hardening. For example, one conventional method of heat treating the component requires heating to a temperature in a range from 840 °C to 860 °C for more than one hour. The component is then quenched in helium or nitrogen gas to produce an as-quenched surface hardness of about 560 HV (53 HRC). Next, the component is tempered at a temperature of 275 °C for a minimum of 1 hour. This produces a core hardness of about 480 HV (48 HRC), which is within the acceptable range of about 430 HV (44 HRC) to about 530 HV (51 HRC). The surface is then induction hardened to achieve a surface hardness of about 657 HV (58 HRC). The induction hardening is performed at a specific frequency with a specific power level for a set time, and the surface is cooled by spraying the component with a fluid at a set temperature and having a set concentration of polymer component until a desired temperature is achieved. After cooling, the component is tempered at a temperature of 120 °C for a minimum of 1 hour.

Using the conventional heat treating process, the anvil 38, for example, typically has a case depth on the lugs 50 in a range of about 1.1 mm to 1.8 mm. The case depth on the shank 54 is typically in a range of about 0.8 mm to 1.15 mm, and the case depth on the drive surfaces 94 is typically in a range of about 1.2 mm to 1.8 mm.

For the camshaft 26, the tip or all of the post 116 is induction hardened so as to increase residual compressive stresses because the tip interfaces with the anvil 38. During operation, the tip of the camshaft post 116 can be subjected to heavy loads, and the additional compressive stresses developed during heat treatment can help offset the heavy loads. In one or more embodiments, the case depth for the tip of the post 116 of the camshaft 26 may be up to about 0.25 mm, which also corresponds to the total depth of the residual compressive stresses.

As will be discussed below, Applicant has identified several different heat treating processes that Applicant expects will significantly increase the hardness of various sections of the power tool component (such as the anvil 38 or camshaft 26), the case depth, the beneficial compressive residual stress field, or any combination thereof as compared to the conventional heat treating process. Further, certain aspects of the disclosed heat treating processes produced surprising and unexpected results achieved by proceeding against the common knowledge in the art.

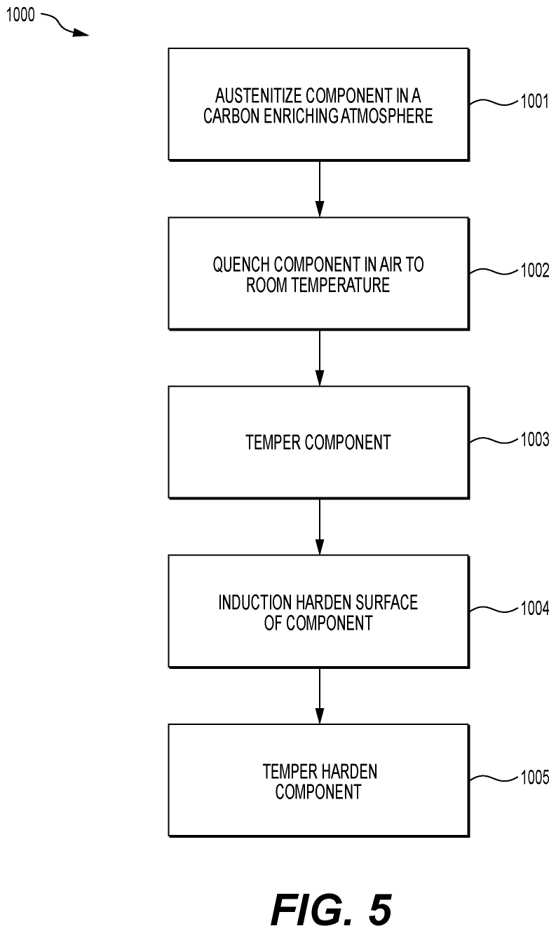

According to a first embodiment of a heat treating method of the present disclosure, the component is austenitized in a carbon enriched atmosphere during the initial heat treatment step to produce a carbon-enriched surface region. In this way, the component is able to maintain a tougher core while significantly increasing the hardness at the surface of the component. FIG. 5 is a flow diagram of a process 1000 for heat treating the power tool component according to the first embodiment of the heat treating process.

In a first step 1001, the component is austenitized at a temperature in a range of 825 °C to 950 °C, in particular about 870 °C, for a time in a range of about 1 hour to about 7 hours, in particular about 4 hours, in a carbon atmosphere with a carbon potential in a range of 0.70% to 0.90%. In a second step 1002, the component is quenched in air to room temperature. Carburizing a medium carbon steel like 35Cr2Ni4MoA or 30NiCrMo8 is contrary to conventional wisdom in the art because the increased carbon content is expected to lead to undesirable residual stresses within the part. However, Applicant found that air quenching surprisingly and unexpectedly reduced the rate of cooling to a sufficient degree that the undesirable residual stresses were avoided. In the as-quenched state, the core hardness of the component is in a range of 525 HV (51 HRC) to 700 HV (60 HRC), in particular about 580 HV (54 HRC).

In a third step 1003 of the method 1000, the component is tempered at a minimum temperature of 250 °C, in particular greater than or equal to about 300 °C, for a minimum time of 1 hour. This produces a final core hardness in a range of 430 HV (44 HRC) to 530 HV (51 HRC), in particular about 480 HV (48 HRC). In a fourth step 1004, the surface of the component is induction hardened to produce a final surface hardness of the component in a range of 650 HV (58 HRC) to 850 HV (65 HRC), in particular about 780 HV (63 HRC). In one or more embodiments, the method 1000 includes a fifth step 1005 of tempering the component at a minimum temperature of 120 °C for a minimum time of 1 hour.

In one or more embodiments, as a result of the first heat treating method 1000, the lugs 50 of the anvil 38 or tip of the camshaft 26 have a case depth in a range of about 2.0 mm to 2.5 mm, and as compared to the conventional heat treating process which produces a maximum surface hardness of about 58 HRC, the first heat treating method 1000 provides a surface hardness of over 60 HRC, in particular about 62 HRC. Because of the carburizing to increase the carbon content at the surface, the surface of the component has a higher hardness and higher wear resistance. Further, because of the air quenching, the component possesses a better residual stress profile and longer life than traditional tempering/carburizing where the rapid gas quench creates much greater thermal stresses that can shorten the lifetime of the anvil. While the foregoing discussion focused primarily on medium carbon steel, such as 35Cr2Ni4MoA or 30NiCrMo8, the disclosed process is also usable with other steels having a greater or lesser degree of hardenability. Additionally, the quenching and tempering parameters, such as carbon equivalent, austenitizing time/temperature, and quench rate, and the induction hardening parameters, such as frequency, time, temperature, and quench rate, can be modified to suit other applications.

According to a second embodiment of a heat treating method of the present disclosure, the component is rapid induction tempered to avoid the phenomena of tempered martensite embrittlement (TME) that can occur when heat treated steel is conventionally tempered through specific temperature ranges. Specifically, TME is known to occur at a temperature in a range of approximately 250 °C to 400 °C. Applicant expects that the rapid induction tempering will dramatically increase the steel toughness compared to the conventional process described above.

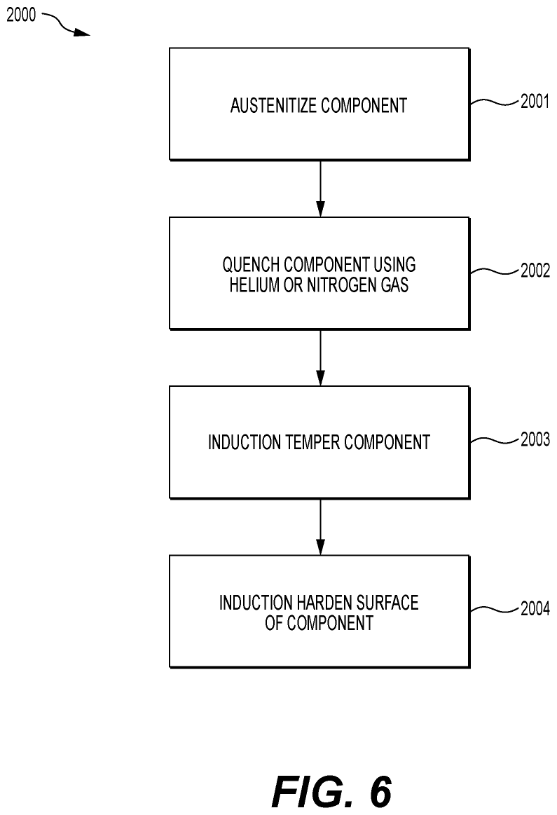

FIG. 6 is a flow diagram of a second heat treating process 2000 according to the present disclosure. In a first step 2001 of the process 2000, the component is austenitized at a temperature in a range of 840 °C to 860 °C for a minimum of 1 hour. In one or more embodiments, the austenitizing is performed in an atmosphere with 0.30% to 0.40% carbon potential. In a second step 2002, the component is quenched in helium or nitrogen gas. As-quenched, the core hardness of the component is in a range of 525 HV (51 HRC) to 700 HV (60 HRC), in particular about 560 HV (53 HRC).

In a third step 2003, the component is induction tempered, in particular at a temperature in a range of 500 °C to 600 °C, particularly at about 550 °C, for a time in a range of 1 second to 10 seconds, in particular about 1 second. Applicant expects that this rapid induction tempering will provide the requisite core hardness in a range of 430 HV to 530 HV while increasing the core toughness in terms of impact strength. In one or more embodiments in which the component is an anvil 38, the anvil 38 is induction tempered in two separate steps, one step to temper the lugs 50 and one step to temper the shaft 54, because of the difference in geometries and thicknesses for these two components of the anvil 38. In one or more embodiments in which the component is a camshaft 26, the flange ring carrier and shaft are induction tempered in different steps to achieve desired performance characteristics of each section with respect to toughness, wear/hardness, and residual stress profile.

In a fourth step 2004, the surface is induction hardened to hardness in a range from 620 HV to 720 HV, in particular about 657 HV (58 HRC). In one or more embodiments in which the component is an anvil 38, the anvil 38 has a case depth on the lugs 50 in a range of about 1.1 mm to 1.8 mm. In one or more embodiments in which the component is an anvil 38, the case depth on the shank 54 of the anvil 38 is in a range of about 0.8 mm to 1.15 mm, and in one or more embodiments in which the component is an anvil 38, the case depth on the drive surfaces 94 of the anvil 38 is in a range of about 1.2 mm to 1.8 mm.

Thus, as compared to the conventional process described above, the disclosed second heat treating process 2000 utilizes an induction tempering step. Conventionally, induction tempering is not performed on induction hardened or quenched and tempered parts because of concerns about reduced toughness and fatigue life. However, Applicant believes that the short induction tempering time actually promotes improved toughness compared to traditional furnace tempering. Further, because of the small size and thickness of the heat-treated components, such as anvils 38 and camshafts 26, Applicant believes that the disclosed rapid induction tempering will be possible and will provide the desired core toughness.

According to a third embodiment of a heat treating method of the present disclosure, the component undergoes intensive quenching to dramatically increase the compressive residual stresses in the core of the component as compared to the conventional process described above. In particular, Applicant expects that the intensive quenching will interrupt the conventional heat treatment quenching process at a point at which maximum compressive stresses are formed in the core of the component. Such residual compressive stresses are known to improve fatigue life of a part.

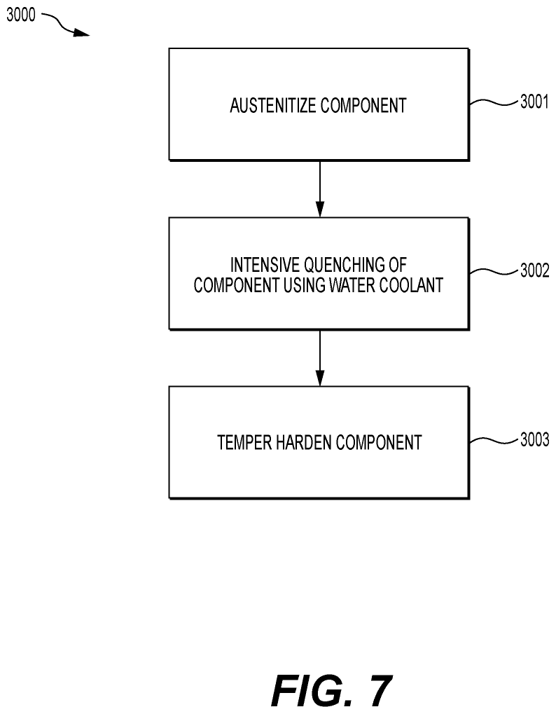

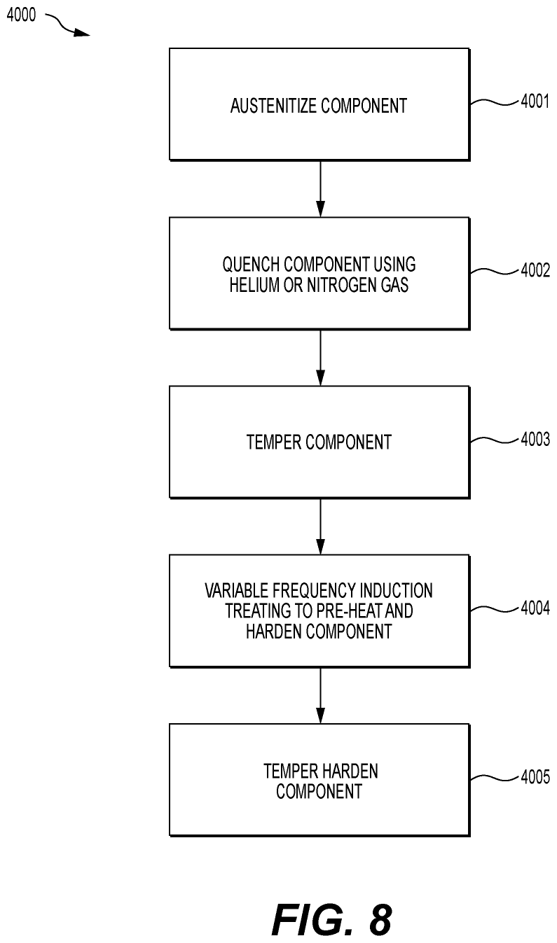

FIG. 7 is a flow diagram of a third heat treating process 3000 according to the present disclosure. In a first step 3001, the component is austenitized at a temperature in a range of 840 °C to 860 °C for a minimum time of 1 hour. In one or more embodiments, the austenitizing step 3001 is performed in an atmosphere with a carbon potential of 0.30% to 0.40%. Conventionally, the austenitizing step 3001 is followed by a gas quench in helium or nitrogen, for example, but according to embodiments of the present disclosure, the second step 3002 is an intensive quenching using water as the coolant. In one or more embodiments, intensive quenching can be carried out using an apparatus and according to methods disclosed in U.S. Publication No. 2023/0374619A1, published on Nov. 23, 2023, which is incorporated herein in its entirety by reference thereto. Advantageously, intensive quenching provides uniform cooling at a fast cooling rate, leading to improved surface hardness and improved toughness of the component. Conventionally, rapid quenching is thought to lead to excessive tensile residual stresses, which can result in part cracking. However, Applicant has found that intensive quenching, especially for the geometry and small size of the components (such as anvils 38 and camshafts 26), results instead in residual compressive stresses, which provides increased fatigue life as discussed above.

After intensive quenching, the component has a surface hardness in a range of 550 HV (53 HRC) to 650 HV (58 HRC), in particular about 620 HV (56 HRC) and a core hardness in a range of 530 HV (51 HRC) to 630 HV (57 HRC). In a third step 3003, the intensively quenched component is tempered at a minimum temperature of 120 °C for a minimum time of 1 hour. After tempering, the core hardness is in a range of a core hardness in a range of 430 HV (44 HRC) to 530 HV (51 HRC), in particular about 480 HV (480 HRC)

According to a fourth embodiment of a heat treating method of the present disclosure, the component undergoes variable frequency induction hardening to create more compressive residual stresses than conventional induction hardening processes. In particular, Applicant expects that varying the frequency during induction hardening will allow for a low-frequency pre-heat step that increases compressive residual stresses followed by a higher-frequency surface hardening step. As discussed above, residual compressive stresses are known to improve fatigue life of a part.

FIG. 8 is a flow diagram of a fourth heat treating process 4000 according to the present disclosure. In a first step 4001, the component is austenitized at a temperature in a range of 840 °C to 860 °C for a minimum time of 1 hour. In one or more embodiments, the austenitizing step 4001 is performed in an atmosphere with a carbon potential of 0.30% to 0.40%. In a second step 4002, the component is quenched in helium or nitrogen gas to produce an as-quenched surface hardness in a range of 620 HV (56 HRC) to 720 HV (61 HRC) and an as-quenched core hardness in a range of 530 HV (51 HRC) to 630 HV (57 HRC), in particular about 560 HV (53 HRC). In a third step 4003, the component is tempered at a minimum temperature of 250 °C, in particular a temperature of greater than or equal to 300 °C, for a minimum of 1 hour. This produces a core hardness in a range of about 430 HV (44 HRC) to about 530 HV (51 HRC), in particular about 480 HV (48 HRC).

In a fourth step 4004, the component is induction hardened using multiple frequencies. As mentioned above, the component is first induction hardened at a lower frequency to preheat the component through its depth, and then the frequency is increased. After variable frequency induction hardening 4004, the surface hardness of the component is in a range of about 620 HV (56 HRC) to 720 HV (61 HRC), in particular about 657 HV (58 HRC). In a fifth step 4005, the component is tempered at a minimum temperature of 120 °C for a minimum time of 1 hour. For the anvil 38, in particular, the variable induction hardening produces a case depth of 1.1 mm to 1.8 mm on the lugs 50, 0.8 mm to 1.15 mm on the shaft 54, and 1.2 to 1.8 mm on the drive surfaces 94.

Conventionally, induction hardening is performed at a single frequency to provide hardening at the surface of a part. As described above in relation to the fourth heat treating process 4000, the induction heater for hardening can be driven at variable frequencies such that multiple frequencies are utilized in the induction hardening step 4004. In this way, the induction hardening step can be used to create residual compressive stresses that improve fatigue life.

According to a fifth embodiment of a heat treating method of the present disclosure, the component undergoes a carbo-austempering step as part of a process to create a bainitic microstructure in the component. The conventional heat treating process as described above produces a martensitic microstructure, but bainite is generally known to possess better impact and toughness properties compared to martensite. In particular, crack propagation through bainite is more difficult than through martensite, which increases the fatigue life of a bainitic steel structure.

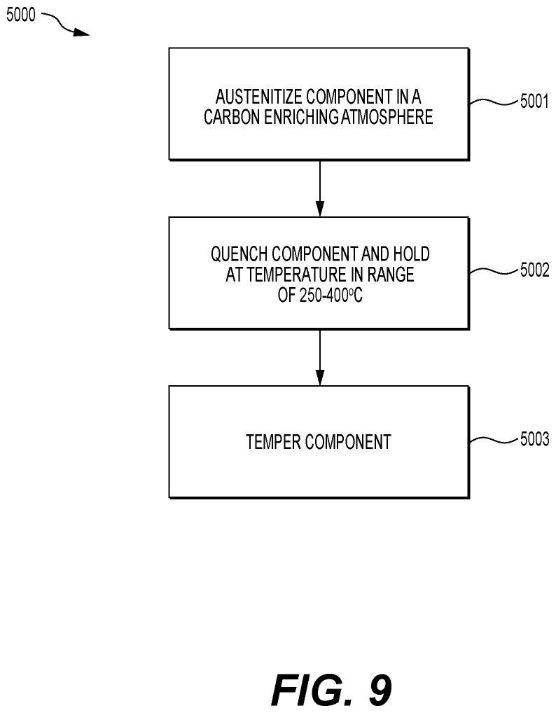

FIG. 9 is a flow diagram of a fifth heat treating process 5000 according to the present disclosure. In a first step 5001, the component is austenitized at a temperature in a range of 825 °C to 950 °C, in particular about 870 °C, for a time in a range of about 1 hour to about 7 hours, in particular about 4 hours, in a carbon atmosphere with a carbon potential in a range of 0.70% to 0.90%. In one or more embodiments, a mild carbon alloy steel is utilized as the component for the fifth heat treating process 5000. During the first step, the component, such as the camshaft, may be masked to prevent carburization of certain surfaces of the component as will be discussed more fully below.

In a second step 5002, the component is quenched. In one or more embodiments, the component is quenched in a salt bath. In one or more other embodiments, the component is quenched in water, oil, or air. In the second step 5002, the component is held at a temperature in a range of 250 °C to 400 °C for a time of at least 30 minutes. After quenching, the component comprises surface hardness in a range of about 650 HV (58 HRC) to about 850 HV (65 HRC).

In a third step 5003, the component is tempered at a minimum temperature of 120 °C, in particular at a temperature of greater than or equal to 150 °C, for a minimum time of 1 hour. After tempering, the component has a final core hardness in a range of 430 HV (44 HRC) to 530 HV (51 HRC), in particular about 460 HV (46 HRC). Tempering tends to drop the surface hardness by 1 to 2 HRC. The case depth on the component is in a range of 2.0 mm to 2.5 mm. Advantageously, this heat treating process does not require a separate induction hardening step.

The fifth heat treating process 5000 according to the present disclosure provides high wear resistance and high hardness because of the high carbon content as a result of carburizing during austenitizing step 5001. Further, because of the quenching 5002, the microstructure of the component is bainite, not martensite, which provide improved fatigue life because of the slower crack propagation through bainite than martensite. Notwithstanding, in one or more embodiments, the fifth heat treating process 5000 can be tailored to provide a microstructure that is substantially bainite (e.g., ≥95%) with some retained martensite (e.g., ≤5%), which has been shown to provide further improved fatigue life. In one or more embodiments, the component may be subject to cryogenic treatment in order to reduce the amount of retained austenite, thereby substantially eliminating retained austenite between bainite plates and also driving transformation of any retained austenite to martensite. In one or more embodiments, cryogenic treatment involves holding the component at a temperature in a range of about −80 °C to about −196 °C for 4 to 20 hours. Thereafter, the component is brought back to room temperature prior to tempering. Such cryogenic treatment allows the steel to transform more retained austenite to martensite, which is generally desirable for high stress applications because it provides increased wear resistance and improved fatigue resistance. Further, cryogenic treatment affects the mechanical properties throughout the component and not just at the surface. Additionally, the quenching 5002, in which the component is held at an elevated temperature, avoids issues with rapid quenching, such as cracking and distortion as described above. Embodiments of this heat treatment process can also be modified with respect to carbon equivalent, austenitizing time and temperature, quenching temperature and hold time, etc. to tailor the process for other parts or applications. Additionally, the heat treatment process is usable with other steels than 35Cr2Ni4MoA and 30NiCrMo8 mentioned herein, e.g., having a greater or lesser degree of hardenability or a lower carbon content (such as 27MnCr5 steel).

In one or more embodiments in which the component has a hollow interior or thin wall thickness, such as for the camshaft 26, the interior surface 126 of the component is masked to limit or prevent case hardening of the interior surface 126 relative to the exterior surface 124, allowing the inner core of the camshaft 26 to remain softer with desired toughness. In one or more embodiments, the masking is applied to the component as a first step for any of the heat treating methods 1000 or 5000 described above in relation to FIGS. 5 and 9 in which the component is austenitized in a carbon-enriching atmosphere. In such processes, the masking is designed to prevent absorption of atmospheric carbon into certain surfaces of the component. In one or more embodiments, the masking of the interior surface 126 is provided by a plug inserted into the hollow interior 122 of the camshaft 26. In one or more such embodiments, the plug is a steel pin formed from a low carbon steel (e.g., 1010 or 1018 steel), an austenitic steel, or a stainless steel. In one or more such embodiments, the plug is sized to be inserted into the interior cavity of the camshaft 26 without any additional sealing material, and the material of such plugs are selected such that volumetric changes of the plug and/or camshaft 26 are not so great as to prevent the plug from sliding out of the camshaft 26 after the carburizing treatment. In one or more other embodiments, the plug is clay. In one or more embodiments, the masking of the interior surface 126 is provided by painting the interior surface 126 of the camshaft 26. In one or more such embodiments, the paint is a stop-off paint, which can be manually or automatedly brushed or rolled onto the camshaft 26. In one or more embodiments, the stop-off pint comprises a solvent or water base and contains boron/boron oxide. Further, in one or more such embodiments, the paint has a thickness in a range of 0.1 mm to 1.0 mm over the interior surface 126. In one or more other embodiments, the mask is metal plating, such as copper plating, applied via an electrodeposition process.

Applicant expects that masking of the component, such as the camshaft 26, will allow for substantially the same heat treatment profile for a hollow interior component as for a solid core component. In this way, the component having the hollow interior will receive the same surface hardening without also substantially hardening the interior surfaces of the component, thereby allowing the component to retain the softer, tougher interior of the component.

Additional details are shown and described in the accompanying FIG.

It should be understood that the figures illustrate the exemplary embodiments in detail, and it should be understood that the present application is not limited to the details or methodology set forth in the description or illustrated in the figures. It should also be understood that the terminology is for description purposes only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one. As used herein, “rigidly coupled” refers to two components being coupled in a manner such that the components move together in a fixed positional relationship when acted upon by a force.

Various embodiments of the disclosure relate to any combination of any of the features, and any such combination of features may be claimed in this or future applications. Any of the features, elements or components of any of the exemplary embodiments discussed above may be utilized alone or in combination with any of the features, elements or components of any of the other embodiments discussed above.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A component of an impact tool, the component comprising:
a first end;
a second end;
a shank portion extending between the first end and the second end, the shank portion comprising an outer surface;
wherein at least a portion of the component comprises a hardness of at least 60 HRC.

2. The component of claim 1, wherein the component is an anvil, wherein the anvil comprises an impact receiving portion at the first end, the impact receiving portion including a lug having an impact receiving surface that receives impact from a hammer of the impact tool, and wherein the anvil comprises a drive portion located at the second end of the shank portion opposite from the impact receiving portion at the first end, the drive portion including a plurality of drive surfaces configured to engage a tool bit.

3. The component of claim 2, wherein the at least a portion of the component comprises the impact receiving surface and wherein the impact receiving surface comprises a case depth of at least 2.0 mm.

4. The component of claim 1, comprising a medium carbon steel containing nickel.

5. The component of claim 1, comprising a steel with alloying additions of more than 4.0 wt. %.

6. The component of claim 1, wherein the component is a camshaft configured to be disposed between a motor at an upstream end and an anvil at a downstream end, the camshaft comprising a flange at the first end, a post at the second end, and wherein the shank portion comprises an interior surface and an exterior surface, the interior surface defining a hollow interior.

7. The component of claim 1, wherein at least a portion of the component comprises a bainitic microstructure.

8. The component of claim 7, wherein the bainitic microstructure comprises retained martensite, the retained martensite being present in an amount of 5% or less.

9. A method of heat treating a component of an impact tool, comprising:
austenitizing the component in a carbon enriching atmosphere with a carbon potential in a range of 0.70% to 0.90%, the component comprising a medium carbon, high alloy steel;
quenching the component in air to room temperature;
tempering the component at a minimum temperature of 250 °C for a minimum time of 1 hour;
induction hardening a surface of the component to a hardness of at least 60 HRC; and
tempering the component at a minimum temperature of 120 °C for a minimum time of 1 hour.

10. The method of claim 9, wherein the component comprises an anvil or a camshaft.

11. The method of claim 10, wherein the component is the camshaft, the camshaft having an exterior surface and an interior surface, the interior surface defining a hollow interior, and wherein the method further comprises masking the interior surface of the camshaft to limit hardening of the interior surface relative to the exterior surface of the camshaft.

12. A method of heat treating a component of an impact tool, comprising:
austenitizing the component;
quenching the component in at least one of helium or nitrogen gas;
induction tempering the component at a temperature in a range of about 500 °C to about 600 °C for a time in a range of about 1 second to about 10 seconds; and
induction hardening a surface of the component to a hardness of at least 56 HRC.

13. The method of claim 12, wherein the component comprises an anvil or a camshaft.

14. A method of heat treating a component of an impact tool, comprising:
austenitizing the component;
intensive quenching the component using water; and
tempering the component at a minimum temperature of 250 °C for a minimum time of 1 hour.

15. The method of claim 14, wherein the component comprises an anvil or a camshaft.

16. A method of heat treating a component of an impact tool, comprising:
austenitizing the component;
quenching the component in at least one of helium or nitrogen gas;
tempering the component at a minimum temperature of 250 °C for a minimum time of 1 hour;
induction hardening the component using a first frequency to pre-heat the component and a second frequency to harden a surface of the component to a hardness of at least 56 HRC; and
tempering the component at a minimum temperature of 120 °C for a minimum time of 1 hour.

17. The method of claim 16, wherein the component comprises an anvil or a camshaft.

18. A method of heat treating of a component of an impact tool, comprising:
austenitizing the component in a carbon enriching atmosphere with a carbon potential in a range of 0.70% to 0.90%;
quenching the component;
holding the component at a temperature in A range of 250 °C to 400 °C for at least 30 minutes; and
tempering the component at a minimum temperature of 120 °C for a minimum time of 1 hour;
wherein the component comprises a bainitic microstructure.

19. The method of claim 18, wherein the component comprises an anvil or a camshaft.

20. The method of claim 19, wherein the component is the camshaft, the camshaft having an exterior surface and an interior surface, the interior surface defining a hollow interior, and wherein the method further comprises masking the interior surface of the camshaft to limit hardening of the interior surface relative to the exterior surface of the camshaft.

21. The method of claim 18, wherein quenching is performed in a salt bath.

22. The method of claim 18, wherein quenching is performed in air, oil, or water.
